(19) United States
(12) Patent Application Publication
(10) Pub. No.: US 2014/0261981 A1
(43) Pub. Date: Sep. 18, 2014

(54) CATHODE COMPOSITE STRUCTURE AND METHODS THEREOF FOR IMPROVED FUEL CELL PERFORMANCE UNDER HIGH HUMIDITY

(71) Applicant: GM GLOBAL TECHNOLOGY OPERATIONS LLC, (US)

(72) Inventor: Bradley M. Houghtaling, Rochester, NY (US)

(73) Assignee: GM GLOBAL TECHNOLOGY OPERATIONS LLC, Detroit, MI (US)

(21) Appl. No.: 13/832,984

(22) Filed: Mar. 15, 2013

(51) Int. Cl. H01M 4/88; H01M 8/10

(52) U.S. Cl. CPC H01M 4/8825; H01M 8/1004
USPC 156/182; 427/115; 156/60

(57) ABSTRACT

Disclosed are methods for fabricating a cathode composite structure to improve fuel cell performance. The methods comprise preparing a cathode composition for a cathode layer, the cathode composition having an average particle size distribution of from about 0.1 to about 30 microns, and simultaneously depositing the cathode composition and at least one other composition onto a substrate such that a cathode layer is formed on the substrate and at least one other layer is formed on the cathode layer to form a cathode composite structure.

### TECHNICAL FIELD

The embodiments described herein generally relate to a process for fabricating a cathode composite structure to improve fuel cell performance, and more particularly, it relates to a process for fabricating a cathode composite structure to improve fuel cell performance by simultaneous application of multiple fuel cell component coatings, including a cathode composition, onto a substrate.

### BACKGROUND

Electrochemical conversion cells, commonly referred to as fuel cells, produce electrical energy by processing reactants, for example, through the oxidation and reduction of hydrogen and oxygen. A polymer electrolyte fuel cell may comprise catalyst coated diffusion media layers in which the catalyst is coated on the gas diffusion media layers with a membrane positioned between the two catalyst coated diffusion media layers. During manufacturing of a fuel cells, catalyst electrode and membrane layers may be simultaneously coated, and in some instance, microporous layers, electrode layers and membrane layers may be simultaneously coated onto gas diffusion media. However, when coating a nonporous layer onto a porous layer, intermixing of the layers and/or the critical ingredients dispersed or dissolved therein can occur. In addition, non-uniform layers can having variable layer thicknesses can result.

Therefore, alternative fuel cells, membrane electrode assemblies, and methods for fabricating membrane electrode assemblies are disclosed herein.

### SUMMARY

In embodiments disclosed herein are methods for fabricating a cathode composite structure to improve fuel cell performance. The methods comprise preparing a cathode composition for a cathode layer, the cathode composition comprising one or more solvents, an ionomer, and a catalyst, and the cathode composition having an average particle size distribution of from about 0.1 to about 30 microns, preparing a membrane composition, the membrane composition comprising one or more solvents and an ionomer, and simultaneously depositing the membrane composition and the cathode composition onto a substrate such that a cathode layer is formed on the substrate and a membrane layer is formed on the cathode layer.

In embodiments also disclosed herein are methods for making a membrane electrode assembly. The methods comprise simultaneously depositing a membrane composition and a cathode composition onto a first substrate such that a cathode layer is formed on the first substrate and a membrane layer is formed on the cathode layer, wherein the cathode composition comprises one or more solvents, an ionomer, and a catalyst, and has an average particle size distribution of from about 0.1 to about 30 microns, and wherein the first substrate, cathode layer and membrane layer together form a cathode composite structure, simultaneously depositing a membrane composition and an anode composition onto a second substrate such that an anode layer is formed on the second substrate and a membrane layer is formed on the anode layer, wherein the second substrate, anode layer and membrane layer together form an anode composite structure, and hot pressing the cathode composite structure to the anode composite structure such that the cathode layer and anode layer are on opposite sides of the membrane.

Additional features and advantages of the embodiments for membrane electrode assemblies, composite structures and methods for fabricating membrane electrode assemblies and composite structures described herein will be set forth in the detailed description which follows, and in part will be readily apparent to those skilled in the art from that description or recognized by practicing the embodiments described herein, including the detailed description which follows, the claims, and the appended drawings.

Both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter

### BRIEF DESCRIPTION OF THE DRAWINGS

FIG. 1 depicts an exemplary 2-layer simultaneous coating method of a fuel cell component according to one or more embodiments shown and/or described herein.

FIG. 2 depicts a comparison of particle size distribution for a cathode composition formed according to one or more embodiments shown and/or described herein.

FIG. 3 depicts scanning electron micrographs comparing cross-sections of a cathode composite structure formed according to one or more embodiments shown and/or described herein.

FIG. 4 depicts a chart comparing performance of a fuel cell formed according to one or more embodiments shown and/or described herein.

### DETAILED DESCRIPTION

Reference will now be made in detail to embodiments of methods for fabricating membrane electrode assemblies and subassemblies, examples of which are illustrated in the accompanying drawings. Whenever possible, the same reference numerals will be used throughout the drawings to refer to the same or like parts.

For the purposes of describing and defining the present invention, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Disclosed herein are methods for fabricating a cathode composite structure to improve fuel cell performance. The methods utilize simultaneous application of multiple fuel cell component coatings, including a cathode composition, onto a substrate. The methods may be use to provide processing improvements in one or more of cost, performance, durability, and manufacturing efficiency. It has been found that simultaneous coating of two or more components can improve manufacturing efficiency and reduce manufacturing costs by reducing the number of passes through the coating machine. In addition, component costs may also be reduced. Using component compositions, for e.g., membrane ionomer compositions, are generally less expensive than purchasing the component parts. Yield improvements may also be realized since fewer passes through a coating machine reduce the likelihood of process defects. There may also be improvements in durability and/or performance when the layers are applied directly to the coating substrate simultaneously resulting in a more intimate and tightly bound interface between the layers. Finally, there may be a cost advantage to coating the functional layers simultaneously, which can result in a reduced amount of raw materials required to meet performance requirements.

As described in greater detail below, the methods generally comprise preparing a cathode composition for a cathode layer, the cathode composition having an average particle size distribution of from about 0.1 to about 30 microns, preparing a membrane composition, and simultaneously depositing the membrane composition and the cathode composition onto a substrate such that a cathode layer is formed on the substrate and a membrane layer is formed on the cathode layer. As used herein, “composition” means true solutions, dispersions and/or emulsions.

There are many possible combinations of compositions that can be simultaneously deposited on a substrate to form a composite structure. Some examples, include, but are not limited to: a membrane composition coated on cathode composition; a cathode composition coated on a microporous composition and a membrane composition coated on the cathode composition; a membrane composition coated on a cathode composition and an anode composition coated on the membrane composition; and a cathode composition coated on a microporous composition, a membrane composition coated on the cathode composition and an anode composition coated on the membrane composition. Of course, other combinations of simultaneously depositing compositions to form a composite structure will be apparent to those of ordinary skill in the art in view of the teachings herein, and can include, for example, several layers of electrodes, membranes or microporous layers using the simultaneous coating processes described herein.

Referring to FIG. 1, an exemplary method (100) for fabricating a composite structure having two coatings simultaneously applied to a substrate is depicted. On the surface of a substrate (105), a membrane composition (115) is simultaneously applied with a cathode composition (110) using a coating die (120). The coating compositions are applied such that the membrane composition is coated on the cathode composition to form a cathode layer on the substrate and a membrane layer on the cathode layer. After application of the coating compositions, the composite structure (130) is sent to a dryer or a series of dryers to dry the coating compositions by solvent removal, thereby forming a composite structure. The resultant composite structure comprises a substrate, a cathode layer formed on the substrate, and a membrane layer formed on the cathode layer.

Prior to the substrate passing through a dryer or series of dryers, a porous reinforcement layer (125) may optionally be applied to the membrane layer to provide additional support to the composite structure. Examples of suitable porous reinforcement layers may include, but are not limited to, a polymer film, a metal screen, a woven fabric, or combinations thereof. Examples of suitable polymer films may include polytetrafluoroethylene (PTFE), expanded polytetrafluoroethylene (ePTFE), polyvinylidene fluoride (PVDF), or fluoroethylene propylene (FEP).

Of course, the method shown in FIG. 1 can be used to fabricate a composite structure having three, four, five, six, etc. coatings simultaneously applied to a substrate. In some embodiments, on the surface of a substrate, a first composition, a second composition and a third composition are simultaneously applied using a coating die. The coating compositions are applied such that the second composition is simultaneously coated on a first composition and the third composition is simultaneously coated on the second composition. After application of the coating compositions, the substrate may be sent to a dryer or a series of dryers to dry the coating compositions by solvent removal, thereby forming a composite structure. An optional reinforcement layer may be added to the membrane layer to provide additional support to the structure prior to the substrate passing through the dryer.

In other embodiments, on the surface of a substrate, a first composition, a second composition, a third composition, and a fourth composition are simultaneously applied using a coating die. The coating compositions are applied such that the second composition is simultaneously coated on a first composition, the third composition is simultaneously coated on the second composition, and the fourth compositions is simultaneously coated on the third composition. After application of the coating compositions, the substrate may be sent to a dryer or a series of dryers to dry the coating compositions by solvent removal, thereby forming a composite structure. An optional reinforcement layer may be added to provide additional support to the structure prior to the substrate passing through the dryer.

In some embodiments, the first composition is a microporous composition, the second composition is a cathode composition, and the third composition is a membrane composition. The resultant composite structure will comprise a coated substrate having a microporous layer formed on the substrate, a cathode layer formed on the microporous layer, and a membrane layer formed on the cathode layer. In other embodiments, the first composition is a cathode composition, the second composition is a membrane composition, and the third composition is an anode composition. The resultant composite structure will comprise a coated substrate having a cathode layer formed on the substrate, a membrane layer formed on the cathode layer, and an anode layer formed on the membrane layer. In further embodiments, the first composition is a microporous composition, the second composition is a cathode composition, the third composition is a membrane composition, and the fourth composition is an anode composition. The resultant composite structure will comprise a coated substrate having a microporous layer formed on the substrate, a cathode layer formed on the microporous layer, a membrane layer formed on the cathode layer, and an anode layer formed on the membrane layer. Of course, other combinations of electrode compositions, including cathode and anode compositions, membrane compositions, and microporous compositions may be used herein.

The coating compositions may be simultaneously applied using a slot die coating process, slide coating process, curtain coating process, and combinations thereof. In a slot die coating process, a coating die may be used that has two or more slots to permit passage of different coating compositions through each slot. In a slide coating process, simultaneous application of two or more coating compositions occurs using a slide hopper. A slide hopper forms a two or more liquid layer composite (i.e., one layer on top of another) that flows down a hopper slide surface, over a hopper lip surface, and onto the substrate. In a curtain coating process, liquid flows out of a slit and falls under gravity (called a curtain) onto a horizontally moving substrate. Similar to the slide coating process, a curtain may be a two or more liquid layer composite. The dryer or series of dryers may include infrared dryers, infrared lamps, hot-air dryers, or other dryers suitable for drying multiple coating composition layers.

It has been surprisingly found that in using the processes disclosed herein, a composite structure may be fabricated having a cathode layer and at least one other layer that are simultaneously coated onto a substrate, while still maintaining a distinct layer relationship between the coatings after deposition. In addition, it has been surprisingly found that in simultaneously coating a cathode composition and at least one other composition comprising solvents and small solid particles onto a substrate, the cathode composition and at least one other composition may be simultaneously applied with no noticeable mixing or contamination at the interface of the layers.

Without wishing to be bound by theory, it is believed that because the cathode becomes porous during the drying step (due to removal of the solvent), the still mobile membrane can seep into the cathode layer via capillary action and/or gravitational forces. The membrane effectively fills the pores of the cathode catalyst layer, which may reduce the ability of water to be transported from the reaction sites, and therefore, increasing the likelihood of flooding. In addition, solvent diffusion between the layers can render the coating unstable, causing unacceptably poor thickness uniformity. Further, diffusion of solid components between the layers can also cause unacceptably poor thickness uniformity, which can influence performance and/or durability of the final unitized electrode assembly (“UEA”). By UEA, we mean an assembly of the membrane, electrodes, and diffusion media as a unit with, for example, other components such as a subgasket, bipolar plates and the like. Thus, it is believed that to obtain a distinct layer relationship in a simultaneous coating process, the average particle size distribution (PSD) of the cathode must at least be reduced to 0.1 to about 30 microns. It is believed that the reduction in the average particle size distribution can lead to a higher packing density, and therefore, a lower porosity present in the cathode layer. The lower porosity is believed to reduce membrane seepage and result in a cathode layer and membrane layer that has a more uniform thickness, and results in distinct cathode and membrane layers.

### Substrates

Suitable substrates may include, but are not limited to, diffusion media (DM), gas diffusion media (GDM), and nonporous substrates, such as polymer films (e.g., polyvinylidene fluoride (PVDF), fluroethylene propylene, polypropylene, polyimide, polyester, or polytetrafluoroethylene (PTFE)), polymer-coated paper (e.g., polyurethane coated paper), silicone release paper, metal foil (e.g., aluminum foil), metallic supports (e.g., stainless steel support), a wheel with a chrome coating, or other nonporous materials. DMs and GDMs may consist of carbon-based substrates, such as carbon paper, woven carbon fabric or cloths, non-woven carbon fiber webs, which are highly porous and provide the reaction gases with good access to the electrodes. Carbon substrates that may be useful in the practice of the present invention may include: Toray™ Carbon Paper, SpectraCarb™ Carbon Paper, AFN™ non-woven carbon cloth, Zoltek™ Carbon Cloth, Zoltek® PWB-3, and the like. DMs and GDMs may also be treated with a hydrophobic fuel and permit removal of water from the fuel cell. Additionally, DMs and GDMs can be coated with a microporous layer in order to improve the contact to the membrane. They can also be tailored specifically into anode-type GDMs or cathode-type GDMs, depending on into which side they are built in a given MEA. In some examples, a porous substrate may have a thickness ranging from about 100 micrometers to about 500 micrometers. In other examples, a porous substrate may have a thickness ranging from about 100 micrometers to about 150 micrometers. In some examples, a non-porous substrate may have a thickness ranging from about 10 micrometers to about 3200 micrometers. In other examples, a non-porous substrate may have a thickness ranging from about 20 micrometers to about 40 micrometers.

### Cathode Composition

The cathode composition comprises one or more solvents, an ionomer, and a catalyst. The cathode composition may also comprise a dispersing aid. Any suitable catalyst may be used in the practice of the present invention. In some embodiments, the catalyst may be catalyst metal coated onto the surface of a electrically conductive support. Generally, carbon-supported catalyst particles are used. Carbon-supported catalyst particles are about 50-90% carbon and about 10%-50% catalyst metal by weight. The catalyst may be a finely divided precious metal having catalytic activity. Suitable precious metals include, but are not limited to, platinum group metal, such as platinum, palladium, iridium, rhodium, ruthenium, and their alloys.

The solvent may include isopropyl alcohol, methanol, ethanol, n-propanol, n-butyl alcohol, sec-butyl alcohol, tert-butyl alcohol, water, 2-methyl-2-butanol, 2-methyl-2-pentanol, 2,3-dimethyl-2-butanol, 2,3-dimethyl-2,3-butanediol, 2,4-dimethyl-2,4-pentanediol, 2,4-dimethyl-2,4-hexanediol, 2,5-dimethylhexan-2,5-diol, 3-hydroxy-3-methyl-2-butanone and 4-hydroxy-4-methyl-2-pentanone (diacetone alcohol) and mixtures thereof. The solvent may be present in the composition in an amount of from 1 to 90% by weight, in some examples from 5 to 80% by weight, and in further examples from 10% to 50% by weight of the cathode composition.

The ionomer material, which may or may not be the same ionomer material used in the membrane composition, may include, but is not limited to, copolymers of tetrafluoroethylene and one or more fluorinated, acid-functional co-monomers, tetrafluoroethylene-fluorovinyl ether copolymer, perfluorosulfonic acids (PFSAs), perfluorocyclobutanes (PFCBs), hydrocarbon polymers, sulfonated polyether ketones, aryl ketones, acid-doped polybenzimidazoles, sulfonated polysulfone, sulfonated polystyrene, and mixtures thereof. Generally, the ionomer materials in the composition should be used in a solvent, i.e. dissolved or dispersed in a suitable solvent. Many fluorine-containing ionomer materials can be obtained in the form of an aqueous solution in various concentrations. The ionomer content of the compositions may range from 5 to 30% by weight of the composition. Of course, ionomer materials supplied in the form of aqueous dispersions may also be used. Such dispersions may include, for example, Nafion® PFSA polymer dispersions sold by DuPont. As described in further detail below, the ionomer materials in the composition may be a low EW ionomer, a high EW ionomer or a blend of ionomer materials having a high EW and a low EW.

Examples of suitable dispersing aids may include, but are not limited to cetyltrimethylammonium bromide; cetyltriethylammonium bromide; oleylamine; primary amines such as n-propyl amine, butyl amine, decyl amine, and dodecyl amine; pyridine; pyrrole; diethanolamine; triethanolamine; polyvinyl alcohol; adamantanecarboxylic acid; eicosanoic acid; oleic acid; tartaric acid; citric acid; heptanoic acid; polyethylene glycol; polyvinylpyrrolidone; tetrahydrothiophene; salts thereof (for example, sodium citrate or potassium oleate), and mixtures thereof.

The cathode composition may be prepared by dispersing catalyst particles and milling media in an ionomer solution comprising ionomer material, solvent, and optionally a dispersing aid to form a catalyst dispersion, and milling the catalyst dispersion to form a cathode composition having an average particle size distribution of from about 0.1 micron to about 30 micron. In embodiments herein, the milling media may have a size of from about 3 mm to about 15 mm, from about 4 mm to about 10 mm, from about 5 mm to about 10 mm, or from about 5 mm to about 8 mm. In embodiments herein, the mass ratio of milling media to electrode ink may be about 6:1, about 7:1, about 8:1, about 9:1 or about 10:1. In some embodiments, the catalyst dispersion may be milled from about 12 hours to about 84 hours, from about 24 hours to about 72 hours, from about 48 hours to about 72 hours. In some embodiments, the catalyst dispersion may be milled for at least about 48 hours, at least about 72 hours or at least about 84 hours. Of course, it should be understood that the size of the milling media, mass ratio and milling time may be varied so long as the resultant cathode composition has an average particle size distribution of from about 0.1 to about 30 microns.

Examples of suitable milling media may include, but is not limited to, ammonium dihydrogen phosphate, aluminum nitride, alumina (Al₂O₃), sapphire, aluminum titanate (Al₂TiO₅), barium fluoride, barium titanate, barium ferrite (BaO₆Fe₂O₃), barium oxide silicate (3BaO.SiO₂), boron carbide, beryllia (BeO), boron nitride, diamond, calcium fluoride (CaF₂ fluorspar), iron oxide (FeO), manganese zinc ferrite, nickel zinc ferrite, strontium ferrite, gallium nitride, gadolinium gallium garnet, graphite, potassium chloride, lithium silicate glass (Li₂O.2SiO₂), magnesium aluminate (MgAl₂O₄), magnesium fluoride, magnesium oxide, magnesium dititanate, mullite, lead zirconate titanate, silicon, sialon, silicon carbide, silicon nitride (Si₃N₄), silicon oxynitride (Si₂N₂O), silicon dioxide, magnesium aluminate (MgAl₂O₄), strontium fluoride, strontium ferrite, strontium zirconate, thorium dioxide, titanium diboride, titanium carbide, titanium nitride, titanium dioxide, uranium dioxide, vanadium carbide, tungsten carbide, yttrium aluminum oxide, yttrium oxide, zinc sulfide, zinc selenide, zirconium nitride, and zirconia. Of course it should be understood that other chemically inert and strong materials may be used as milling media.

As noted above, the catalyst is applied to the substrate using a cathode composition. The cathode composition may contain 5%-30% solids (i.e. ionomer and catalyst) and, in some examples, may contain 10%-20% solids. In some embodiments, the cathode composition may have an average particle size distribution of from about 0.1 microns to about 30 microns, from about 0.1 microns to about 20 microns, from about 0.1 microns to about 15 microns, or from about 0.1 microns to about 10 microns. In some embodiments, the solids contained in the cathode composition may have a particle size distribution such that at least 80% of the solids have a particle size diameter ranging from about 0.01 microns to about 30 microns, from about 0.01 microns to about 20 microns, from about 0.01 microns to about 15 microns, from about 0.01 microns to about 10 microns. In some embodiments, the solids contained in the cathode composition may also have a particle size distribution such that at least 90% of the solids have a particle size diameter ranging from about 0.01 microns to about 30 microns, from about 0.01 microns to about 20 microns, from about 0.01 microns to about 15 microns, or from about 0.01 microns to about 10 microns.

Other additives, such as binders, cosolvents, crack reducing agents, wetting agents, antifoaming agents, surfactants, anti-settling agents, preservatives, pore formers, leveling agents, stabilizers, pH modifiers, milling aids and other substances, can be used in the cathode composition to improve coatablity. Furthermore, basic agents such as sodium hydroxide (NaOH) or potassium hydroxide (KOH) can be added for buffering of the acid groups of the ionomer.

In some examples, a crack reducing agent is added to the cathode composition. Cathodes can form a network of cracks on the surface, which is called “mud cracking.” It is believed that “mud cracking” occurs due to the stresses that develop as wet film dries and the solid materials begin to consolidate. Not wishing to be bound by theory, the cracks may form due to stress gradients resulting from local thickness differences in the wet film. The cracks may also form following drying due to an inherent weakness of the electrode. The electrode is formed from a porous matrix of the carbon support bound by the ionomer, which is a relatively weak binder. As a result, the matrix of the carbon support provides minimal reinforcement to the ionomer, and the resulting matrix may not withstand the substantial stresses during the drying of the catalyst ink, resulting in a greater opportunity for the cracks to form during operation of the fuel cell. If the tensile strength of the film is insufficient to overcome the induced drying stress, mud cracks can form to relieve the film of the stress. Thus, a crack reducing agent may be added to the catalyst electrode ink to prevent the formation of mud cracks.

Examples of suitable crack reducing agents can include, but are not limited to, the addition of relatively high boiling solvents, for example, diacetone alcohol, carbon fibers, nanoclay platelets (for example available from Southern Clay Product of Gonzales, Tex.), or a mixture of low equivalent weight ionomers and high equivalent weight ionomers, or combinations thereof. The diacetone alcohol may be present in an amount up to about 30 wt. % of a cathode ink. The carbon fibers may be about 10-20 micrometers in length and 0.15 μm in diameter. The carbon fibers may be present in a ratio of about 1:6 (w/w) fibers:catalyst. Also, as disclosed above, the catalyst ink comprises ionomer material. Low equivalent weight (less than about 800EW) ionomers or a mixture of low equivalent weight ionomers and high equivalent weight ionomers (greater than about 800EW) may be used to mitigate the occurrence of mud cracks. In some examples, the ionomer material may be a mixture of ionomers having a high equivalent weight of greater than about 850 and a low equivalent weight of less than about 750.

### Anode Composition

Similar to the cathode composition, the anode composition comprises a solvent, an ionomer, and a catalyst. The anode composition may further comprise a dispersing aid. The solvent, ionomer, catalyst, and dispersing as disclosed above in forming the cathode may also be used to form the anode. The anode composition may also use a carbon-supported catalyst, as described above, or a non-carbon-supported catalyst. The anode composition may be prepared by adding catalyst and milling media to a bottle, along with the solvent and ionomer to form an anode dispersion. The anode dispersion may then be milled by, for e.g., placing the bottle containing the anode dispersion on a ball mill and rotating the bottle in the presence of milling media.

### Membrane Composition

The membrane composition may comprise one or more solvents and an ionomer. The ionomers useful in the present invention may be highly fluorinated and, in some examples, perfluorinated, but may also be partially fluorinated or non-fluorinated. Examples of fluorinated ionomers useful in the present invention can include copolymers of tetrafluoroethylene and one or more fluorinated, acid-functional co-monomers, tetrafluoroethylene-fluorovinyl ether copolymer, perfluorosulfonic acids (PFSAs), perfluorocyclobutanes (PFCBs), or mixtures thereof. The ionomer materials may be used in a liquid composition, i.e. dissolved or dispersed in a suitable solvent. Many fluorine-containing ionomer materials can be obtained in the form of an aqueous solution in various concentrations. The ionomer content of the compositions may range from 5 to 30% by weight of the composition. Of course, ionomer materials supplied in the form of aqueous dispersions may also be used. Such dispersions may include, for example, Nafion® PFSA polymer dispersions sold by DuPont. Examples of fluorine-free, ionomer materials that may be used can include hydrocarbon polymers, sulfonated polyether ketones, aryl ketones, acid-doped polybenzimidazoles, sulfonated polysulfone, and sulfonated polystyrene. The membranes may generally be coated such that the wet thickness of the membrane layer ranges from about 50 μm to about 150 μm. In some examples, the membrane layer formed by the processes herein may have a dry thickness ranging from about 3 μm to about 30 μm. In some examples, the membrane layer formed by the process may have a dry thickness ranging from about 4 μm to about 10 μm.

The membrane layer may use a ionomer having an equivalent weight (EW) of 1200 or less, in some examples 1100 or less, in other examples 1000 or less, in other examples 900 or less, and in other examples 800 or less. By “equivalent weight” (EW) of a ionomer, it is meant the weight of ionomer required to neutralize one equivalent of base. In some examples, the membrane may comprise a blend of ionomers having a different EW.

In some examples, the membrane layer may be annealed after a drying step to help obtain the necessary durability. Membrane layers may also benefit from the use of optional reinforcement layers to improve the mechanical strength of the membrane so that it is less susceptible to stress-related failures. Examples of suitable reinforcement layers include expanded Teflon (ePTFE), metal screens, woven fabrics, and other suitable materials apparent to those of ordinary skill in the art. In some examples, the membrane layer and the reinforcement layer may be annealed together. In other examples, the electrode, membrane and reinforcement layers may be annealed together. Annealing can involve heating the membrane layer to a temperature above its glass transition temperature, then slowly cooling it down to form crystalline domains in an arrangement that imparts rigidity and strength to the membrane layer.

Ion-exchange membranes can degrade over time when subjected to the chemical environment found in a typical polymer electrolyte membrane fuel cell. To reduce membrane degradation, the use of chemical degradation mitigants may be required. Suitable chemical degradation mitigants that inhibit membrane degradation may include cerium-containing compounds, manganese-containing compounds, and a porphyrin-containing compound. In one example, the mitigant comprises a platinum nanoparticle, CeO₂, or MnO₂. Other suitable examples may include a soluble sulfonate (SO₄⁻²), carbonate (CO₃⁻²) or nitrate (NO₃⁻²) salt of any of the following metal ions alone, or in combination, Co²⁺, Co³⁺, Fe²⁺, Fe³⁺, Mg¹⁺, Mg²⁺, Mn¹⁺, Mn²⁺, Mn³⁺, Cl Mn³⁺, HO Mn³⁺, Cu¹⁺, Cu²⁺, Ni¹⁺, Ni²⁺, Pd¹⁺, Pd²⁺, Ru¹⁺, Ru²⁺, Ru⁴⁺, Vn⁴⁺, Zn¹⁺, Zn²⁺, Al³⁺, B, Si(OH)₂²⁺, Al³⁺, HOIn³⁺, Pb²⁺, Ag⁺, Sn²⁺, Sn⁴⁺, Ti³⁺, Ti⁴⁺, VO⁺, Pt²⁺, Ce³⁺, or Ce⁴⁺.

Microporous Composition [we can Describe, Even Though we Don't have Examples for Breadth]

The microporous composition may comprise one or more solvents, carbon particles, and a hydrophobic polymer. The term “carbon particles” is used to describe carbon in any finely divided form, (the longest dimension of any of the particles is suitably less than 500 μm, less than 100 μm, less than 50 μm) including carbon powders, carbon flakes, carbon nanofibers or microfibers, and particulate graphite. The carbon particles may be carbon black particles. Examples of suitable hydrophobic polymers may include polytetrafluoroethylene (PTFE), polyvinylidene fluoride (PVDF), fluoroethylene propylene (FEP), or other organic or inorganic hydrophobic polymer materials. The carbon particles and hydrophobic polymer may be dispersed in a liquid, which may be, for example, an organic solvent, water and mixtures thereof. In some examples, the solvent may include at least one of isopropyl alcohol, methanol, ethanol, n-propanol, n-butyl alcohol, sec-butyl alcohol, tert-butyl alcohol, water, 2-methyl-2-butanol, 2-methyl-2-pentanol, 2,3-dimethyl-2-butanol, 2,3-dimethyl-2,3-butanediol, 2,4-dimethyl-2,4-pentanediol, 2,4-dimethyl-2,4-hexanediol, 2,5-dimethylhexan-2,5-diol, 3-hydroxy-3-methyl-2-butanone, 4-hydroxy-4-methyl-2-pentanone (diacetone alcohol) and mixtures thereof. As previously described, the microporous composition may be simultaneously applied with other coating compositions onto a substrate.

The microporous layer formed after drying the microporous composition may comprise, in some examples, about 50%-90% carbon particles, and about 10%-45% hydrophobic polymer. The microporous layer may be between 2 μm and 100 μm thick, and in some examples between 10 μm and 70 μm thick. The porosity of the microporous layer can suitably be greater than 50%, and in some examples, greater than 70%. The pore sizes in the microporous layer may cover a wide range, e.g. from 5 nm up to 10 μm.

Also disclosed herein are methods of making a membrane electrode assembly. The methods generally comprise preparing a cathode composite structure, preparing an anode composite structure, and hot pressing the cathode composite structure to the anode composite structure. The cathode composite structure may be prepared by simultaneously depositing a membrane composition and a cathode composition onto a first substrate such that a cathode layer is formed on the first substrate and a membrane layer is formed on the cathode layer, wherein the cathode composition has an average particle size distribution of from about 0.1 to about 30 microns. The first substrate, cathode layer and membrane layer together form a cathode composite structure. The anode composite structure may be prepared by simultaneously depositing a membrane composition and an anode composition onto a second substrate such that an anode layer is formed on the second substrate and a membrane layer is formed on the anode layer. The second substrate, anode layer and membrane layer together form an anode composite structure. The membrane layer of cathode composite structure and the membrane layer of the anode composite structure are hot pressed together. This results in the cathode layer and the anode layer being on opposite sides of the joined membrane layer. It should be understood that laminating or another related approach for joining the cathode composite structure to the anode composite structure may be used.

In some embodiments, the cathode composite structure may be prepared by simultaneously depositing a membrane composition, a cathode composition, and a microporous composition onto a first substrate such that a microporous layer is formed on the first substrate, a cathode layer is formed on the microporous layer, and a membrane layer is formed on the cathode layer, wherein the cathode composition has an average particle size distribution of from about 0.1 to about 30 microns.

In some embodiments, an optional reinforcement layer may be applied to the cathode composite structure and the anode composite structure. Suitable reinforcement layers may include the reinforcement materials previously discussed above.

The embodiments described herein may be further illustrated by the following non-limiting examples.

### EXAMPLES

Except where noted, a 2-layer slot die moving relative to the coating supports was used. Catalyst loadings for electrodes were determined gravimetrically. Membrane thickness was determined by a drop gauge. The coated parts were dried via infrared drying. Where noted, expanded Teflon (ePTFE) was affixed to the wet membrane when coated with the cathode and/or anode before substantial drying took place.

### Cathode Composition and Preparation

Cathode ink #1 (inventive) was prepared by adding 6.02 grams of a 30% Pt-alloy catalyst (supplied by Tanaka Kikinzoku International) and 600 grams of 5 mm spherical zirconia milling media to a first 250 ml polyethylene bottle. In a second 250 ml polyethylene bottle, 6.70 grams of a 900 equivalent weight (EW) ionomer (28 wt. % solids, 42 wt. % ethanol, 30 wt. % water) and 3.02 grams of a 700EW ionomer (20.5 wt. % solids, 79.5 wt. % water) were added, along with 36.64 grams of ethanol, 22.03 grams of water and 0.59 grams of a 26.7 wt. % oleylamine, 55 wt. % n-propanol and 18.3 wt. % water solution. The contents of the second bottle were stirred for about 15 minutes. The ionomer solution from the second bottle was then added to the catalyst and milling media in the first bottle. The first bottle was then placed on a ball mill and rotated at 145 RPMs for 72 hrs.

Cathode ink #2 (Reference) was prepared identically to cathode ink #1, except 300 grams of 5 mm spherical zirconia milling media to a first 125 ml polyethylene bottle and the first bottle was then placed on a ball mill and rotated at 145 RPMs for 24 hrs.

The particle size distribution was determined for Cathode ink #1 (inventive) and cathode ink #2 (reference) and is depicted in FIG. 2. As illustrated, the inventive cathode composition has a particle size distribution that primarily ranges from about 0.1 microns to about 10 microns, whereas the reference cathode composition has a particle size distribution that primarily ranges from about 0.1 microns to about 70 microns.

A non-porous membrane solution was prepared by adding 38.76 grams of a 650 EW ionomer dispersion (20.4 wt. % solids, 47.8 wt. % water and 31.8 wt. % ethanol), 28.79 grams of ethanol and 9.44 grams of water to a 125 ml polyethylene bottle and allowed to mix overnight.

On the surface of a piece of gas diffusion media (“GDM”) (supplied by Freudenberg FCCT KG), the non-porous membrane solution and cathode ink were simultaneously coated under laminar flow onto the GDM substrate such that the non-porous membrane layer was coated on the cathode ink layer to form a wet composite structure. The wet film thickness of the cathode ink layer was 93 microns, and has a Pt loading of 0.2 mg/cm². The wet film thickness of the membrane layer was 160 microns, and had a dry thickness of about 7-9 microns. After the 2 layers were coated and before any substantial drying, a piece of ePTFE (Donaldson D1326) was placed on the wet membrane surface. After applying the ePTFE, the wet composite structure was then allowed to sit until the membrane solution was fully imbibed into the ePTFE. The wet composite structure was then dried under an infrared lamp with a source temperature of 450° F. for about 10 minutes to form a dry cathode composite structure having a substrate, a cathode formed on the substrate, and a non-porous membrane formed on the cathode. Cathode composite structures were formed using the inventive cathode composition and the reference cathode composition.

Referring to FIG. 3, depicted are scanning electron micrographs of a cathode composite structure formed using the inventive cathode composition (305) and a cathode composite structure formed using the reference cathode composition (310). The inventive cathode composite structure (305) shows the substrate (315), cathode layer (320), membrane layer (325), and the reinforcement layer (330) with minimal interlayer mixing (332), which is the whiteish area between the cathode layer (320) and the membrane layer (325). Also, the layers have a substantially uniform thickness. On the contrary, the reference cathode composite structure (310) shows the substrate (335), cathode layer (340), membrane layer (345), and the reinforcement layer (350) with substantial interlayer mixing (352), which is the large whiteish area between the cathode layer (340) and the membrane layer (345) and non-uniform layer thickness.

### Anode Composition and Preparation

Anode ink was prepared by adding 6.62 grams of a 20% Pt of graphitized Vulcan catalyst (supplied by Tanaka Kikinzoku International) and 520 grams of 5 mm spherical zirconia milling media were added to a first 250 ml polyethylene bottle. In a second 250 ml polyethylene bottle, 22.53 grams of a 900 equivalent weight (EW) ionomer (28 wt. % solids, 42 wt. % ethanol, 30 wt. % water), 20.75 grams of ethanol, 13.72 grams of water and 1.39 grams of a 26.7 wt. % oleylamine, 55 wt. % n-propanol and 18.3 wt. % water solution were added and the contents stirred for 15 minutes. The ionomer solution from the second bottle was then added to the catalyst and milling media in the first bottle. The first bottle was then placed on a ball mill and rotated at 125 RPMs for 72 hrs. The same non-porous membrane solution that was used with the cathode ink described above was also used for the anode ink.

On the surface of a piece of GDM (supplied by Freudenburg FCCT KG), the non-porous membrane solution and anode ink were simultaneously coated under laminar flow onto the GDM substrate such that the non-porous membrane layer was coated on the anode ink layer to form a wet composite structure. The wet film thickness of the anode ink layer was 25 microns, and had a Pt loading of 0.05 mg/cm². The wet film thickness of the membrane was 160 microns, and has a dry thickness of about 7-9 microns. The wet composite structure was then placed under an infrared lamp with a source temperature of 450° F. for about 10 minutes to form a dry anode composite structure having a substrate, an anode formed on the substrate, and a non-porous membrane formed on the anode.

### MEA Preparation

In forming a membrane electrode assembly (MEA), the cathode composite structure and the anode composite structure may be dried and then hot pressed together to form the MEA. The pressure and time for the hot press may vary for different types of MEAs. Hot pressing conditions were as follows:
Temperature=295° F.
Time=2 mins.
Force=4000 lbs

An inventive MEA was formed using the inventive cathode composite structure and the anode composite structure. A reference MEA was formed using the reference cathode composite structure and the anode composite structure. Referring to FIG. 4, depicted is a typical polarization curve comparison of the inventive MEA and the reference MEA. The MEAs were run at 80° C., 100% relative humidity (i.e., high humidity conditions), and 170 kPa abs. The voltage was measured at various current densities. As shown, the inventive MEA outperformed the reference MEA.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of fabricating a cathode composite structure to improve fuel cell performance, the method comprising:
preparing a cathode composition for a cathode layer, the cathode composition comprising one or more solvents, an ionomer, and a catalyst, and the cathode composition having an average particle size distribution of from about 0.1 to about 30 microns;
preparing a membrane composition, the membrane composition comprising one or more solvents and an ionomer; and
simultaneously depositing the membrane composition and the cathode composition onto a substrate such that a cathode layer is formed on the substrate and a membrane layer is formed on the cathode layer.

2. The method of claim 1, wherein preparing the cathode composition comprises milling the catalyst composition using milling media.

3. The method of claim 2, wherein the mass ratio of milling media to cathode composition is 8:1.

4. The method of claim 1, wherein the method further comprises drying the cathode layer and the membrane layer.

5. The method of claim 1, wherein the method further comprises applying a porous reinforcement layer to the membrane composition.

6. The method of claim 1, wherein the cathode composition has an average particle size distribution of from about 0.1 to about 20 microns.

7. The method of claim 1, wherein the cathode composition has an average particle size distribution of from about 0.1 to about 10 microns.

8. The method of claim 1, wherein the method further comprises:
preparing an anode composition, the anode composition comprising one or more solvents, an ionomer, and a catalyst; and
simultaneously depositing the anode composition, the membrane composition and the cathode composition onto a substrate such that a cathode layer is formed on the substrate, a membrane layer is formed on the cathode layer, and an anode layer is formed on the membrane layer.

9. The method of claim 8, wherein the method further comprises drying the cathode layer, the membrane layer, and the anode layer.

10. The method of claim 1, wherein the method further comprises:
preparing a microporous composition, the microporous composition comprising one or more solvents, carbon particles, and a hydrophobic polymer; and
simultaneously depositing the membrane composition, the cathode composition, and the microporous composition onto a substrate such that a microporous layer is formed on the substrate, a cathode layer is formed on the microporous layer, and a membrane layer is formed on the cathode layer.

11. The method of claim 10, wherein the method further comprises drying the microporous layer, the cathode layer and the membrane layer.

12. The method of claim 10, wherein the method further comprises applying a porous reinforcement layer to the membrane composition.

13. The method of claim 1, wherein the method further comprises:
preparing a microporous composition, the microporous composition comprising one or more solvents, carbon particles, and a hydrophobic polymer;
preparing an anode composition, the anode composition comprising one or more solvents, an ionomer, and a catalyst; and
simultaneously depositing the anode composition, the membrane composition, the cathode composition, and the microporous composition onto a substrate such that a microporous layer is formed on the substrate, a cathode layer is formed on the microporous layer, a membrane layer is formed on the cathode layer, and an anode layer is formed on the membrane layer.

14. The method of claim 13, wherein the method further comprises drying the microporous layer, the cathode layer, the membrane layer, and the anode layer.

15. A method of making a membrane electrode assembly, the method comprising
simultaneously depositing a membrane composition and a cathode composition onto a first substrate such that a cathode layer is formed on the first substrate and a membrane layer is formed on the cathode layer, wherein the cathode composition comprises one or more solvents, an ionomer, and a catalyst, and has an average particle size distribution of from about 0.1 to about 30 microns, and wherein the first substrate, cathode layer and membrane layer together form a cathode composite structure;
simultaneously depositing a membrane composition and an anode composition onto a second substrate such that an anode layer is formed on the second substrate and a membrane layer is formed on the anode layer, wherein the second substrate, anode layer and membrane layer together form an anode composite structure; and
hot pressing the membrane layer of the cathode composite structure to the membrane layer of the anode composite structure together.

16. The method of claim 15, wherein the method further comprises drying the cathode composite structure and the anode composite structure.

17. The method of claim 15, wherein preparing the cathode composition comprises milling the catalyst composition using milling media.

18. The method of claim 17, wherein the mass ratio of milling media to cathode composition is 8:1.

19. The method of claim 15, wherein the cathode composition has an average particle size distribution of from about 0.1 to about 20 microns.

20. The method of claim 15, wherein the cathode composition has an average particle size distribution of from about 0.1 to about 10 microns.
